(19) United States
(12) Patent Application Publication
(10) Pub. No.: US 2020/0408645 A1
(43) Pub. Date: Dec. 31, 2020

(54) METHOD, DEVICE, AND SYSTEM FOR ESTIMATING LIFE OF A TECHNICAL SYSTEM

(71) Applicant: SIEMENS AKTIENGESELLSCHAFT, Munich (DE)

(72) Inventors: Vinay Ramanath, Bengaluru, Karnataka (IN); Asmi Rizvi Khaleeli, Bangalore, Karnataka (IN); Ajay Kumar Tharwani, Bhilwara, Rajasthan (IN); Garrett Waycaster, Pineville, NC (US)

(21) Appl. No.: 16/982,580

(22) PCT Filed: Mar. 19, 2019
(86) PCT No.: PCT/EP2019/056869

§ 371 Date: Sep. 20, 2020

Related U.S. Application Data
(63) Continuation of application No. 15/926,252, filed on Mar. 20, 2018, now abandoned.

(51) Int. Cl. G01M 99/00; G06Q 10/04; G06Q 50/04

(52) U.S. Cl. CPC G01M 99/007; G06Q 50/04; G06Q 10/04; G01M 99/005

(57) ABSTRACT

A method, a device, and a system of life estimation of a technical system including at least one material are disclosed. The method includes generating a coefficient distribution by determining a probability distribution of condition coefficients associated with the material. The condition coefficients include a stress-strain coefficient, a stress-life coefficient, and structure coefficients. The method also includes sampling the coefficient distribution at a high confidence region and a low confidence region. The life of the material is estimated based on the sampled high confidence region and the sampled low confidence region.

This application is the National Stage of International Application No. PCT/EP2019/056869, filed Mar. 19, 2019, which claims the benefit of U.S. patent application Ser. No. 15/926,252, filed Mar. 20, 2018. The entire contents of these documents are hereby incorporated herein by reference.

### BACKGROUND

The present embodiments relate generally to life estimation of a technical system.

Generally, materials used in technical systems are chosen to improve the performance of efficiency of the technical system. To improve the efficiency of the technical system, life prediction of material used in components of the technical system is determined.

The material life models are used to characterize both inherent behavior variations in material as well as confidence in a given model when faced with limited test data. Traditionally, safety factors derived from prior experience are used to understand variations in the material. With the usage of new materials, accurate representation of variability of the materials may be provided.

### SUMMARY AND DESCRIPTION

This summary is provided to introduce a selection of concepts in a simplified form that are further disclosed in the detailed description. This summary is not intended to identify key or essential inventive concepts of the claimed subject matter, nor is the summary intended for determining the scope of the claimed subject matter.

In accordance with one aspect, a method of life estimation of a technical system is provided. The technical system is made up of one or more materials. The method includes generating a coefficient distribution by determining probability distribution of condition coefficients associated with the material. The condition coefficients include a stress-strain coefficient, a stress-life coefficient, and structure coefficients. Further, the method includes sampling the coefficient distribution at a high confidence region and a low confidence region. Further, the method includes estimating life of the material based on the sampled high confidence region and the sampled low confidence region.

In an embodiment, the method includes weighing the samples based on a confidence function on each of the condition coefficients. The high confidence region indicates on higher confidence function of the condition coefficients as with respect to the low likelihood region with lower confidence function. Further, the sampling is performed by sampling the coefficient distribution at the high confidence region at a faster rate in relation to the low confidence region.

In accordance with another aspect, there is provided a life estimation device for a technical system. The technical system is made up of one or more materials. The device includes a receiver to receive test data and one or more processors. The device also includes a memory communicatively coupled to the at least one processor. The memory further includes a distribution module to generate a coefficient distribution from the test data by determining probability distribution of condition coefficients associated with the material. For example, the condition coefficients include a stress-strain coefficient, a stress-life coefficient, and structure coefficients. The memory includes a sampling module to sample the coefficient distribution at a high confidence region and a low confidence region. The method also includes a life estimation module to estimate life of the material based on the sampled high confidence region and the sampled low confidence region.

In accordance with yet another aspect, a life estimation system for a technical plant is provided. The technical plant includes multiple technical systems made up of one or more materials. The system includes a server operable on a cloud computing platform and a network interface communicatively coupled to the server. The system also includes a life estimation device for each of the technical systems to estimate life of the one or more materials of the technical system.

### BRIEF DESCRIPTION OF THE DRAWINGS

FIG. 1 illustrates stages of life estimation of materials of a technical system, according to an embodiment;

FIG. 2 illustrates stages of determining coefficient distribution according to an embodiment;

FIG. 3 illustrates sampling of a coefficient distribution based on confidence regions, according to an aspect of an embodiment;

FIG. 4 is a flowchart illustrating a method of estimation life of a technical system made up of one or more materials, according to an embodiment;

FIG. 5 is a block diagram of a life estimation device according to an embodiment; and

FIG. 6 is a block diagram of a life estimation system for a technical plant according to an embodiment.

### DETAILED DESCRIPTION

Various embodiments are described with reference to the drawings, where like reference numerals are used to refer to like elements throughout. In the following description, turbine has been considered as an example of a technical system for the purpose of explanation. Further, numerous specific details are set forth in order to provide thorough understanding of one or more embodiments of the present invention. These examples are not be considered to limit the application of the invention to turbines and includes any technical system such as motors, medical instruments, or any structure having a material life that is to be estimated. Such embodiments may be practiced without these specific details limiting the application to turbines.

As used herein, the term “test data” refers to the data recorded in relation to operation of a material in a technical system, such as a rotor in a turbine for a spectrum of operating conditions. The data recorded reflects the condition of the technical system, such as strain, stress, temperature, etc. The condition of the technical system is provided as “condition coefficients” and may also be referred to as parameters or attributes of the technical system. For example, the condition coefficients include a stress-strain coefficient, a stress-life coefficient, and structure coefficients of the rotor in the turbine.

Further, the test data is used to determine load capability of the material prior to failure. The test data may be recorded for multiple materials capable of being used in the making of the technical systems. In the present embodiments, “test data” may also be referred to as “observed data”.

The term “fatigue” refers to a failure mode caused by cyclic loading of the technical system. The fatigue may be empirically determined based on stress-life analysis and the strain-life analysis. Fatigue life of the technical system or a component of the technical system is determined by crack initiation, crack propagation, and final failure. The fatigue life is affected by uncertainties caused by material properties, model errors, parameter estimates, load variation, and structural component properties in engineering. The present embodiments specifically address the model errors to improve estimation of life of the technical system.

As used herein, “probability distribution” refers to a probabilistic model of variation in load on the technical system and variation in input parameters to the technical system. The probabilistic model is modelled as distributions to provide probable distributions of performance of the technical system.

Hereinafter, “prior” refers to known knowledge or assumption of parameters associated with the technical system. For example, priors are coefficients used in determining the condition of the technical system, such as the stress-strain coefficient, the stress-life coefficient, and the structure coefficients. Further, the priors are distributed based on variations in load and input parameters. Accordingly “prior distribution” is generated. As used herein, “prior distribution” also refers to “coefficient distribution.” For example, the probability distribution of the stress-life coefficient for a combustor in a turbine is a coefficient distribution.

The term “likelihood” refers to a measure of support provided by the test data or observed data for each coefficient distribution values associated with the technical system. A function of the likelihood is referred to as “likelihood function” or “confidence function.”

As used herein, “posterior” refers to a combination of known knowledge or assumptions and confidence on the observed data with respect to the known knowledge. The probability distribution of the “posterior” is referred to as “posterior distribution.”

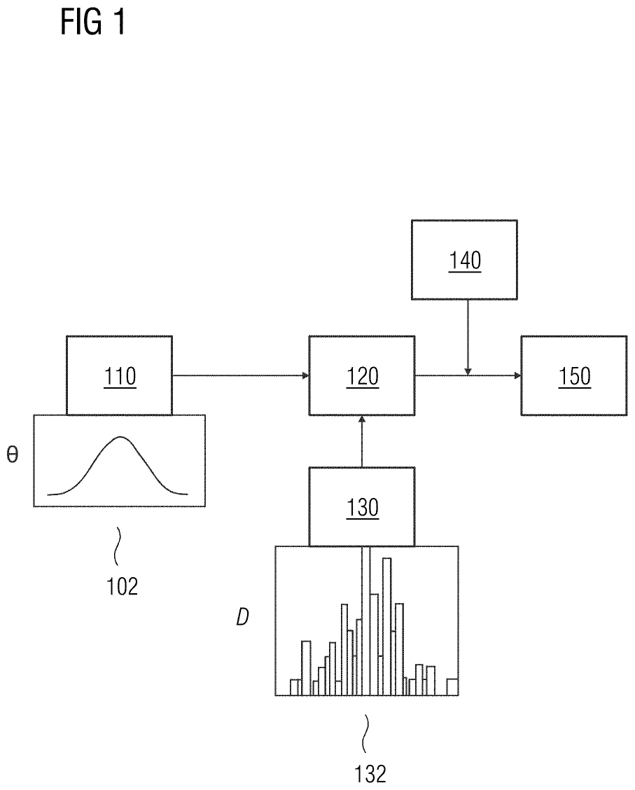

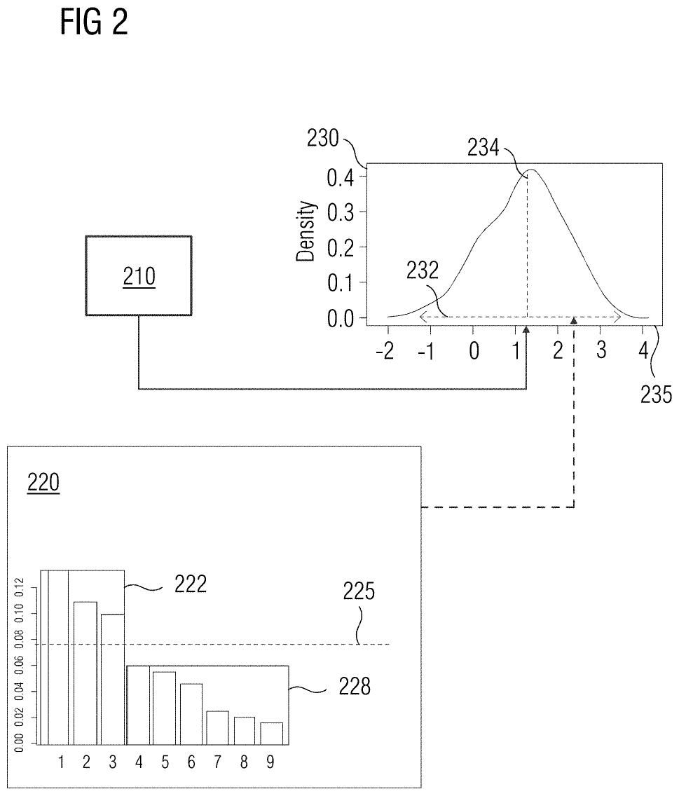

FIG. 1 illustrates stages of estimation life of materials of a technical system, according to the present embodiments. As shown in FIG. 1, the prior/condition coefficients associated with the technical system is denoted by θ. At stage 110, probabilistic distribution of the condition coefficients is determined. Accordingly, the coefficient distribution 102 is a graph indicating the probabilistic distribution of the condition coefficients. The acts performed to accurately determine the coefficient distribution is further elaborated in FIG. 2.

At stage 120, the confidence function L is determined. To determine the confidence function, test data D is obtained at stage 130. As shown in the FIG. 1, the test data is indicated by graph 132.

Based on the confidence function L determined at stage 120, nested sampling is performed at stage 140. The term “nested sampling” refers to a sampling method to relate the confidence function with the coefficient distribution. The sampling method results in nested contours of the confidence function with regard to the coefficient distribution.

At stage 150, posterior distribution P is determined. The posterior distribution is a distribution of estimated life of the technical system. Accordingly, the posterior distribution is determined by the below equation.

$$P ( θ \vert D ) = \frac{π ( θ ) L ( θ )}{\int π ( θ ) L ( θ ) d θ}$$

where π is the prior distribution, L is the likelihood or the confidence function, and d indicates the dimensions for the numerical integration.

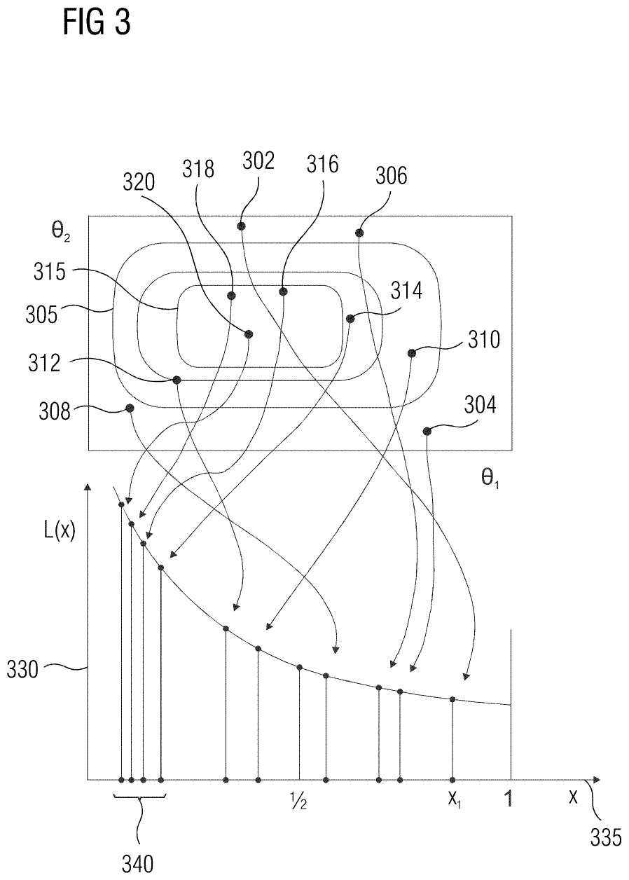

The advantage of the nested sampling is that the posterior distribution is arrived at a faster rate with improved accuracy. The nested sampling enables transformation of coefficient distribution from multi-dimensional integral into a one-dimensional integral. The acts performed in the nested sampling stage 140 and the posterior distribution stage 150 are further elaborated in FIG. 3.

FIG. 2 illustrates stages of determining coefficient distribution according to the present embodiments. As indicated herein above, coefficient distribution and prior distribution are used interchangeably. As shown in FIG. 2, at stage 210, optimized condition coefficients are determined. The optimized condition coefficient θₒₚₜ is indicated in the graph at 234. Further, at stage 210, deterministic optimization is used to determine a mean of the condition coefficient. Accordingly, “optimized condition coefficient θₒₚₜ” is also referred to as a prior mean.

A deterministic optimization approach is advantageous in view of a high number of inter-dependent condition coefficients. The present method of optimization avoids assuming a coefficient distribution through the trial and error approach, which is prone to errors. In an embodiment, a particle swarm optimization method is used to determine the optimized condition coefficients.

At stage 220, sensitivity analysis is performed on the condition coefficients to determine a width of the coefficient distribution. As used herein, the width of the coefficient distribution is also referred to as “distribution limits.” The distribution limits are generated by determining the variance around the optimized condition coefficient θₒₚₜ.

The sensitivity analysis is depicted by a bar graph with condition coefficients on the x-axis and a density on the y-axis. The more sensitive condition coefficients 222 are determined with respect to a sensitivity cut-off 225. The sensitivity cut-off is programmable or pre-determined based on the physics of the technical system. The less sensitive condition coefficients 228 are indicated below the sensitivity cut-off 225.

In an embodiment, a surrogate model is constructed on test data from the technical system. On the surrogate model, a sensitivity analysis is applied. In another embodiment, data of the surrogate model may be obtained from prediction models. As used herein, “sensitivity” refers to influence of perturbations in input parameters.

As shown in FIG. 2, the condition coefficients 235 are plotted against density 230 on the y-axis. The optimized condition coefficient 234 is indicated as the mean of the prior. Further, the distribution limits 232 derived from the sensitivity analysis stage 220 indicate the limits of the coefficient distribution.

In an embodiment, in case of higher sensitivity, the range is determined by

a=θₒₚₜ−0.01*θₒₚₜ and b=θₒₚₜ+0.01*θₒₚₜ

In case of lower sensitivity, the range is determined by

a=θₒₚₜ−0.5*θₒₚₜ and b=θₒₚₜ+0.5*θₒₚₜ

The variance around the prior mean is derived by

$$\frac{{( b - a )}^{2}}{12} .$$

Accordingly, to sum up, the determination of mean in the coefficient distribution is the result of the outcome after performing a deterministic optimization. The sensitivity analysis is employed as a reasoning scheme for arriving at variance to the mean.

FIG. 3 illustrates sampling of the coefficient distribution based on confidence regions. As used herein, “confidence region” is derived by determining the likelihood or confidence from the test data with respect to the condition coefficients. As shown in FIG. 3, the condition coefficients 302-320 are plotted in two-dimensional (2D) space as a contour map of condition coefficients θ₁ and θ₂. The concentric contours in the contour map indicate a same confidence in the confidence region. For example, an outermost contour 305 indicates a same confidence value in a lesser confidence region. While innermost contour 350 indicates a same confidence value in a higher confidence region.

FIG. 3 also includes a plot of the confidence L(x) 330 versus vector x 335 of the condition coefficients θ₁ and θ₂. As shown in the plot at 340, the high confidence region inside and around the contour 350 is sampled more frequently as compared to the lower confidence regions. The method of sampling the high confidence region at a faster rate than the lower confidence regions is referred to as “Nested Sampling.”

In an embodiment, the nested sampling is performed to calculate posterior weights that are used to derive estimated life of the technical system. The equation pᵢ=Lᵢ*wᵢ is used to calculate posterior weights, where pᵢ is posterior weight, Lᵢ is the likelihood/confidence value of the i^{th} iteration, and wᵢ quantifies the condition coefficients.

Using nested sampling, estimated life of the technical system is generated from the condition coefficients that have highest support in the test data. Accordingly, the nested sampling method addresses the drawbacks associated with the popular Markov Chain Monte Carlo (MCMC) sampling method, which requires tuning parameters from a user.

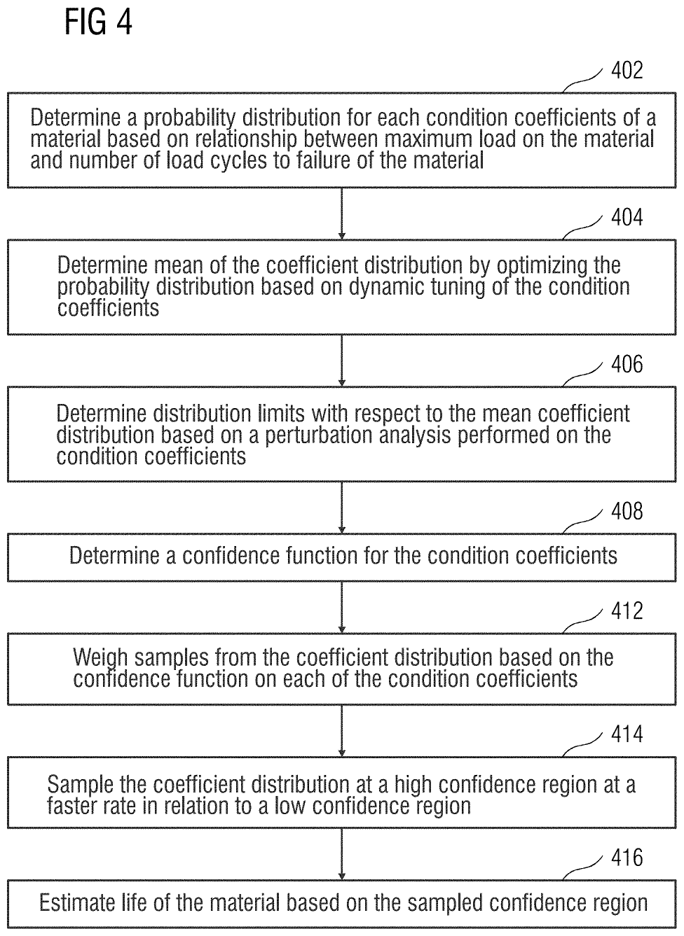

FIG. 4 is a flowchart illustrating one embodiment of a method of estimation life of a technical system made up of one or more materials. The method begins at act 402 with the determination of a probability distribution for each condition coefficient of the material. The probability distribution is determined based on a relationship between maximum load on the material and a number of load cycles to failure of the material. For example, condition coefficients include a fatigue strength exponent, a fatigue ductility coefficient, etc. The probability distribution of the condition coefficients is referred hereinafter as coefficient distribution.

At act 404, the mean of the coefficient distribution is determined by optimizing the probability distribution based on dynamic tuning of the condition coefficients. The dynamic tuning is performed by optimization methods such as particle swarm optimization. Thereafter at act 406, distribution limits with respect to the mean coefficient distribution are determined based on a perturbation analysis performed on the condition coefficients. The generation of the coefficient distribution from the optimized probability distribution and the perturbation analysis has been explained with reference to FIG. 2.

At act 408, a confidence function for the condition coefficients is determined as a measure of the support provided in the test data. At act 412, the confidence function is used to weigh samples from the coefficient distribution. In other words, samples from the coefficient distribution are weighed based on the confidence function on each of the condition coefficients. At act 414, the samples from the high confidence region are obtained at a faster rate in relation to a low confidence region. The confidence regions are obtained from the confidence function, and the sampling process is explained in FIG. 3.

At act 416, life of the materials of the technical system is estimated based on the sampled coefficient distribution. The method is advantageous, as the sampling probes the entire coefficient distribution and in succession samples from the more likely regions of the condition coefficient space. The samples taken outside the likely regions with negligible posterior weights are neglected automatically, and hence, post processing is not required.

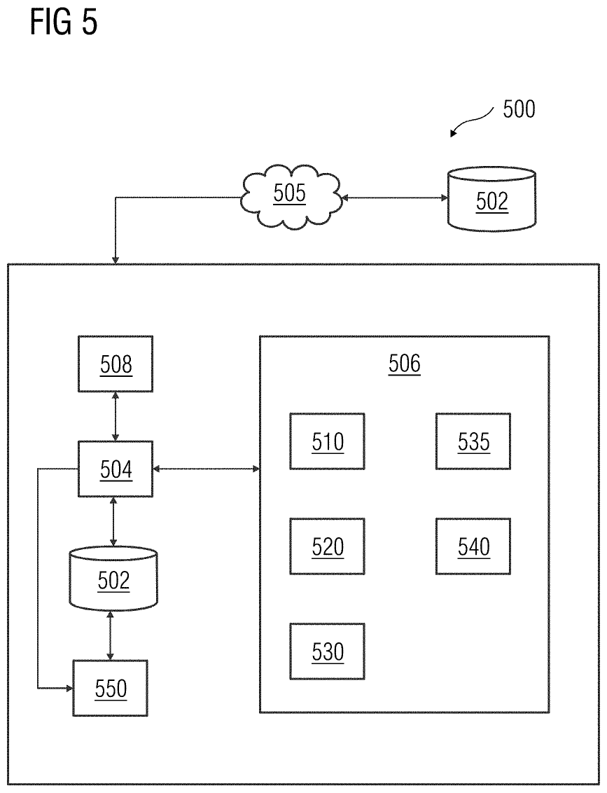

FIG. 5 is a block diagram of one embodiment of a life estimation device 500. The life estimation device 500 according to the present embodiments is installed on and accessible by a user device via, for example, a personal computing device, a workstation, a client device, a network enabled computing device, any other suitable computing equipment, and combinations of multiple pieces of computing equipment. The life estimation device disclosed herein is in operable communication with a database 502 over a communication network 505.

The database 502 is, for example, a structured query language (SQL) data store or a not only SQL (NoSQL) data store. In an embodiment of the database 502, the database 502 may also be a location on a file system directly accessible by the life estimation device 500. In another embodiment of the database 502, the database 502 is configured as a cloud based database implemented in a cloud computing environment, where computing resources are delivered as a service over the network 505.

As used herein, “cloud computing environment” refers to a processing environment including configurable computing physical and logical resources (e.g., networks, servers, storage, applications, services, etc.) and data distributed over the network 505 (e.g., the Internet). The cloud computing environment provides on-demand network access to a shared pool of the configurable computing physical and logical resources. The communication network 505 is, for example, a wired network, a wireless network, a communication network, or a network formed from any combination of these networks.

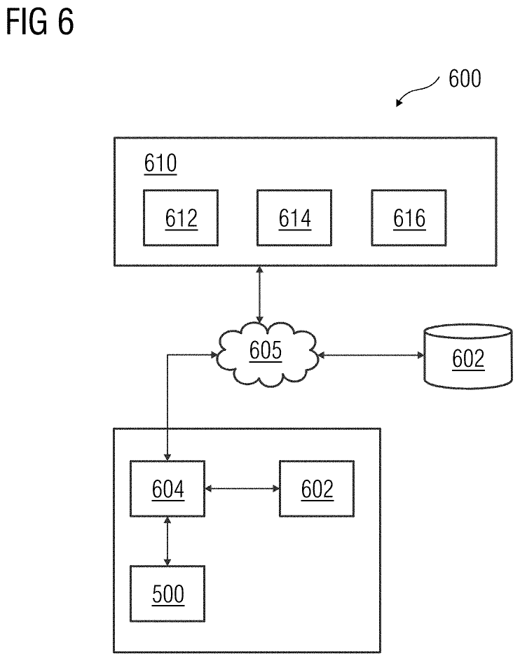

In an embodiment, the life estimation device 500 is downloadable and usable on the user device. In another embodiment, the life estimation device is configured as a web based platform (e.g., a website hosted on a server or a network of servers). In another embodiment, the life estimation device is implemented in the cloud computing environment. The life estimation device is developed, for example, using Google App engine cloud infrastructure of Google Inc., Amazon Web Services® of Amazon Technologies, Inc., as disclosed hereinafter in FIG. 6. In an embodiment, the life estimation device is configured as a cloud computing based platform implemented as a service for analyzing data.

The life estimation device disclosed herein includes memory 506 and at least one processor 504 communicatively coupled to the memory 506. As used herein, “memory” refers to all computer readable media (e.g., non-volatile media, volatile media, and transmission media except for a transitory, propagating signal). The memory is configured to store computer program instructions defined by modules (e.g., 510, 520, 530, etc.) of the life estimation device. The processor 504 is configured to execute the defined computer program instructions in the modules. Further, the processor 504 is configured to execute the instructions in the memory 506 simultaneously.

As illustrated in FIG. 5, the life estimation device includes a communication unit 508 including a receiver to receive the test data from the technical system and a display unit 550. Additionally, a user using the user device may access the life estimation device via a graphic user interface (GUI). The GUI is, for example, an online web interface, a web based downloadable application interface, etc.

The modules executed by the processor 504 include distribution module 510, sampling module 520, validation module 530, confidence function module 535, and life estimation module 540.

The distribution module 510 generates a coefficient distribution from test data by determining probability distribution of condition coefficients associated with the material. For example, the condition coefficients include stress-strain coefficient, stress-life coefficient, and structure coefficients. Estimation of the distribution of the condition coefficients is significant to the estimation of life of the technical system. This is because correct assumption of the condition coefficients leads to accurate life estimate.

The distribution module 510 accurately predicts the mean of the condition coefficient distribution by optimizing probability distribution of the condition coefficients. The optimization is performed based on dynamic tuning of the condition coefficients.

Further, the distribution module 510 determines variance with respect to the mean by a perturbation analysis. The perturbation analysis includes classification of sensitivity. In an embodiment, the classification of sensitivity is determined based on expected life of the technical system. To classify sensitivity, a cut-off criterion is chosen based on the assumption that highly sensitive parameters contribute more to the response variation and less sensitive parameters contribute lesser to the response variation. In an embodiment, the cut-off criterion is determined based on the 80-20 rule. Accordingly, highly sensitive parameters contribute 80% to the response variation, and less sensitive parameters contribute 20% to the response variation.

After the coefficient distribution is determined by the distribution module 510, the sampling module 520 is used to sample the coefficient distribution at based on a confidence function. The confidence function is determined using the validation module 530 and the confidence function module 535.

The validation module 530 validates each of the condition coefficients with known condition of the material. The known condition includes material domain knowledge, test data associated with the material, a physics model, and a mathematical model of the technical system. The confidence module 535 then determines the confidence function based on the validation of each of the condition coefficients.

As a result of the confidence function, the coefficient distribution may be mapped into high confidence regions and low confidence regions. The high confidence region indicates on a higher confidence function of the condition coefficients as with respect to the low likelihood region with a lower confidence function.

The sampling module 520 samples the coefficient distribution at the high confidence region at a faster rate in relation to the low confidence region. The method of sampling is referred to as nested sampling, and the same has been elaborated under FIG. 3, herein above.

The life estimation module 540 then estimates life of the material based on the sampled high confidence region and the sampled low confidence region. The life estimation module estimates life by determining a posterior distribution P. The posterior distribution is a distribution of estimated life of the technical system. Accordingly, the posterior distribution is determined by the below equation.

$$P ( θ \vert D ) = \frac{π ( θ ) L ( θ )}{\int π ( θ ) L ( θ ) d θ}$$

where π is the prior distribution, L is the likelihood or the confidence function, and d indicates the dimensions for the numerical integration.

FIG. 6 is a block diagram of one embodiment of a life estimation system 600 for a technical plant 610. The system 600 includes a server 604 including the life estimation device 500. The system 600 also includes a network interface 605 communicatively coupled to the server 604 and the technical plant 610 including technical systems 612-616. The server 604 includes the life estimation device 500 for estimating life of at least one material in the technical systems 612-616 of the technical plant.

In an embodiment, the technical plant 610 may be located in a remote location, while the server 604 is located on a cloud server, for example, using Google App engine cloud infrastructure of Google Inc., Amazon Web Services® of Amazon Technologies, Inc., the Amazon elastic compute cloud EC2® web service of Amazon Technologies, Inc., the Google® Cloud platform of Google Inc., the Microsoft® Cloud platform of Microsoft Corporation, etc. In case the server 604 is a cloud server, the life estimation device 500 is also implemented in the cloud computing environment.

The life estimation system 600 also includes a database 602. The database 602 may be a cloud database connected to the network interface 605. In another embodiment, the database 602 is connected to the server 604. The database 602 includes information relating to operation of the technical plant including details of the conditions such as, material domain knowledge, test data associated with the material, a physics model, and a mathematical model of the technical systems 612-616.

The above disclosed method, device, and system may be achieved via implementations with differing or entirely different components, beyond the specific components, and/or circuitry set forth above. With regard to such other components (e.g., circuitry, computing/processing components, etc.) and/or computer-readable media associated with or embodying the present embodiments, for example, aspects of the present embodiments may herein be implemented consistent with numerous general purpose or special purpose computing systems or configurations. Various exemplary computing systems, environments, and/or configurations that may be suitable for use with the disclosed subject matter may include, but are not limited to, various clock-related circuitry, such as within personal computers, servers, or server computing devices such as routing/connectivity components, hand-held or laptop devices, multiprocessor systems, microprocessor-based systems, set top boxes, smart phones, consumer electronic devices, network PCs, other existing computer platforms, distributed computing environments that include one or more of the above systems or devices, etc.

In some instances, aspects of the present embodiments herein may be achieved via logic and/or logic instructions including program modules, executed in association with the circuitry, for example. In general, program modules may include routines, programs, objects, components, data structures, etc. that perform particular tasks or implement particular control, delay, or instructions. The present embodiments may also be practiced in the context of distributed circuit settings where circuitry is connected via communication buses, circuitry or links. In distributed settings, control/instructions may occur from both local and remote computer storage media including memory storage devices.

The system and computing device along with corresponding components herein may also include and/or utilize one or more types of computer readable media. Computer readable media may be any available media that is resident on, associable with, or may be accessed by such circuits and/or computing components. By way of example, and not limiting, computer readable media may include computer storage media and communication media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium that may be used to store the desired information and may be accessed by a computing component. Communication media may include computer readable instructions, data structures, program modules, or other data embodying the functionality herein. Further, communication media may include wired media such as a wired network or direct-wired connection, and wireless media such as acoustic, RF, infrared, 4G and 5G cellular networks, and other wireless media. Combinations of the any of the above are also included within the scope of computer readable media.

In the present description, the terms component, module, device, etc. may refer to any type of logical or functional circuits, blocks, and/or processes that may be implemented in a variety of ways. For example, the functions of various circuits and/or blocks may be combined with one another into any other number of modules. Each module may even be implemented as a software program stored on a tangible memory (e.g., random access memory, read only memory, CD-ROM memory, hard disk drive) to be read by a central processing unit to implement the functions of the present embodiments. Or, the modules may include programming instructions transmitted to a general purpose computer or to processing/graphics hardware via a transmission carrier wave. Also, the modules may be implemented as hardware logic circuitry implementing the functions encompassed by the present embodiments herein. Finally, the modules may be implemented using special purpose instructions (SIMD instructions), field programmable logic arrays, or any mix thereof that provides the desired level performance and cost.

As disclosed herein, implementations and features consistent with the present embodiments may be implemented through computer-hardware, software, and/or firmware. For example, the systems and methods disclosed herein may be embodied in various forms including, for example, a data processor, such as a computer that also includes a database, digital electronic circuitry, firmware, software, or any combination thereof. Further, while some of the disclosed implementations describe components such as software, systems, and methods consistent with the present embodiments herein may be implemented with any combination of hardware, software, and/or firmware. The above-noted features and other aspects and principles of the present embodiments herein may be implemented in various environments. Such environments and related applications may be specially constructed for performing the various processes and operations according to the present embodiments, or the environments may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the present embodiments herein, or it may be more convenient to construct a specialized apparatus or system to perform the required methods and techniques.

Aspects of the method and system described herein, such as the logic, may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits. Some other possibilities for implementing aspects include: memory devices, microcontrollers with memory (e.g., EEPROM), embedded microprocessors, firmware, software, etc. Further, aspects may be embodied in microprocessors having software-based circuit emulation, discrete logic (e.g., sequential and combinatorial), custom devices, fuzzy (e.g., neural) logic, quantum devices, and hybrids of any of the above device types. The underlying device technologies may be provided in a variety of component types (e.g., metal-oxide semiconductor field-effect transistor (MOSFET) technologies like complementary metal-oxide semiconductor (CMOS), bipolar technologies like emitter-coupled logic (ECL), polymer technologies such as silicon-conjugated polymer and metal-conjugated polymer-metal structures, mixed analog and digital, etc.)

The various logic and/or functions disclosed herein may be enabled using any number of combinations of hardware, firmware, and/or as data and/or instructions embodied in various machine-readable or computer-readable media, in terms of behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (e.g., uploads, downloads, e-mail, etc.) over the Internet and/or other computer networks via one or more data transfer protocols (e.g., hypertext transfer protocol (HTTP), file transfer protocol (FTP), simple mail transfer protocol (SMTP), etc.).

Unless the context clearly requires otherwise, throughout the description and the claims, the words “comprise,” “comprising,” and the like are to be construed in an inclusive sense as opposed to an exclusive or exhaustive sense (i.e., in a sense of “including, but not limited to”). Words using the singular or plural number also include the plural or singular number respectively. Additionally, the words “herein,” “hereunder,” “above,” “below,” and words of similar import refer to this application as a whole and not to any particular portions of this application.

Although certain implementations have been specifically described herein, it will be apparent to those skilled in the art that variations and modifications of the various implementations shown and described herein may be made without departing from the scope of the inventions herein. Accordingly, it is intended that the inventions be limited only to the extent required by the appended claims and the applicable rules of law.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method of estimating life of a technical system comprising at least one material, the method comprising:
generating a coefficient distribution, the generating of the coefficient distribution comprising determining probability distribution of condition coefficients associated with the material, wherein the condition coefficients include a stress-strain coefficient, a stress-life coefficient, and structure coefficients;
sampling the coefficient distribution at a high confidence region and a low confidence region; and
estimating the life of the material based on the sampled high confidence region and the sampled low confidence region.

2. The method of claim 1, wherein generating the coefficient distribution comprises:
determining the probability distribution for each of the condition coefficients of the material based on a relationship between a maximum load on the material and a number of load cycles to failure of the material;
determining a mean of the probability distribution, the determining of the mean of the probability distribution comprising optimizing the probability distribution based on dynamic tuning of the condition coefficients; and
generating the coefficient distribution based on the mean of the probability distribution.

3. The method of claim 2, further comprising:
determining distribution limits from the mean based on a perturbation analysis performed on the condition coefficients; and
generating the coefficient distribution based on the distribution limits.

4. The method of claim 1, wherein sampling the coefficient distribution at the high confidence region and the low confidence region comprises:
weighing samples based on a confidence function on each of the condition coefficients, wherein the high confidence region indicates on a higher confidence function of the condition coefficients as with respect to the low likelihood region with a lower confidence function; and
sampling the coefficient distribution at the high confidence region at a faster rate in relation to the low confidence region.

5. The method of claim 4, wherein weighing the samples based on a confidence function on each of the condition coefficients, comprises:
determining the confidence function on each of the condition coefficients.

6. The method of claim 5, wherein determining the confidence function on each of the condition coefficients comprises:
validating each of the condition coefficients with a known condition of the material, wherein the known condition comprises material domain knowledge, test data associated with the material, a physics model, and a mathematical model; and
determining the confidence function based on the validation of each of the condition coefficients.

7. A life estimation device for a technical system, the technical system comprising at least one material, the life estimation device comprising:
a receiver configured to receive at least one test data;
at least one processor; and
a memory communicatively coupled to the at least one processor, the memory comprising:
a distribution module configured to generate a coefficient distribution from the test data, the generation of the coefficient distribution comprising determination of a probability distribution of condition coefficients associated with the material, wherein the condition coefficients include a stress-strain coefficient, a stress-life coefficient, and a structure coefficients;
a sampling module configured to sample the coefficient distribution at a high confidence region and a low confidence region; and
a life estimation module configured to estimate life of the material based on the sampled high confidence region and the sampled low confidence region.

8. The device of claim 7, wherein the distribution module is configured to determine the probability distribution for each of the condition coefficients of the material based on a relationship between a maximum load on the material and a number of load cycles to failure of the material.

9. The device of claim 7, wherein the distribution module is configured to determine a mean of the probability distribution, the determination of the mean of the probability distribution comprising optimization of the probability distribution based on dynamic tuning of the condition coefficients, and
wherein the distribution module is configured to generate the coefficient distribution based on the mean of the probability distribution.

10. The device of claim 8, wherein the distribution module is configured to determine distribution limits from the mean based on a perturbation analysis performed on the condition coefficients, and
wherein the coefficient distribution is generated based on the distribution limits.

11. The device of claim 7, further comprising:
a validation module configured to validate each of the condition coefficients with a known condition of the material, wherein the known condition comprises material domain knowledge, test data associated with the material, a physics model, and a mathematical model; and
a confidence function module configured to determine the confidence function based on the validation of each of the condition coefficients.

12. The device of claim 7, wherein the sampling module is configured to weigh the samples based on a confidence function on each of the condition coefficients,
wherein the high confidence region indicates on a higher confidence function of the condition coefficients as with respect to the low likelihood region with a lower confidence function, and
wherein the sampling module is configured to sample the coefficient distribution at the high confidence region at a faster rate in relation to the low confidence region.

13. A life estimation system for a technical plant, the technical plant comprising a plurality of technical systems, each technical system of the plurality of technical systems comprising at least one material, the life estimation system comprising:
a server operable on a cloud computing platform;
a network interface communicatively coupled to the server;
a life estimation device for each technical system of the plurality of technical systems, the life estimation device comprising:
a receiver configured to receive at least one test data;
at least one processor; and
a memory communicatively coupled to the at least one processor, the memory comprising:
a distribution module configured to generate a coefficient distribution from the test data, the generation of the coefficient distribution comprising determination a probability distribution of condition coefficients associated with the material, wherein the condition coefficients include a stress-strain coefficient, a stress-life coefficient, and structure coefficients;
a sampling module configured to sample the coefficient distribution at a high confidence region and a low confidence region; and
a life estimation module configured to estimate life of the material based on the sampled high confidence region and the sampled low confidence region.
